(19) United States
(12) Patent Application Publication
(10) Pub. No.: US 2010/0088603 A1
(43) Pub. Date: Apr. 8, 2010

(54) Medical patient device

(76) Inventors: Uwe Kraemer, IIvesheim (DE); Sebastian Liedtke, Heidelberg (DE)

Correspondence Address: ROCHE DIAGNOSTICS OPERATIONS INC., 9115 Hague Road, Indianapolis, IN, 46250-0457, US

(21) Appl. No.: 12/570,728

(22) Filed: Sep. 30, 2009

(30) Foreign Application Priority Data
Oct. 2, 2008 (EP) 08017377.6

(51) Int. Cl. G06F 3/048; G06F 9/24; G06F 17/30

(52) U.S. Cl. 715/727; 715/765; 713/1; 707/705

(57) ABSTRACT

A medical patient device having a medical measurement unit for detecting and processing analysis-specific signals, a computer unit, a user interface, a configuration data interface for receiving configuration files and having a memory unit, wherein the medical patient device is arranged and adapted so that by means of the user interface, a user can load configuration files into the patient device via the configuration data interface and store them in the memory unit, and can configure the user interface by accessing the downloaded configuration files stored in the memory unit.

### REFERENCE

This application claims priority to European Patent Application No. EP 08 017 377.6 filed 2 Oct. 2008, which is hereby incorporated by reference.

### FIELD

The disclosure relates to a medical patient device and, in particular, to a medical patient device for carrying out and/or analyzing a medical self-test and/or for self-administration of medication, drugs, or the like, in each case by the patient himself or herself.

### BACKGROUND

In the field of medicine, it is known to use portable patient devices for collecting patient data. These portable devices are often connected to central data processing devices in which monitoring, selection, analysis, etc. of the data is carried out either by medical staff or doctors, or in an automated fashion. Such medical patient devices are known and available on the market, for example blood glucose meters, which are used to collect and monitor blood glucose values of diabetics. For example, EP 1 559 364 A1 discloses a wireless diabetes monitoring system in which, after transmitting his or her blood glucose values to a center, the patient is given suitable advice over a mobile telephone on how to proceed. Another system is known from US 2005/0089150 A1 in which, by means of the telephone and portable devices, interactive advice is given to the user/patient by means of speech recognition systems and software-generated instructions.

People suffering from diabetes mellitus should try to keep their blood glucose value constantly within a particular range. If the target range is exceeded, it may be necessary to inject insulin. If the value falls below the target range, then for example sugar may be taken orally (in food or a drink). If the target range is exceeded for a prolonged period of time, there is a risk of severe health complications such as blindness, kidney damage, necrosis of limbs or neuropathy. Inter alia, short-term significant exceeding of the range can lead to nausea, dizziness, sweating and even states of confusion. If the value falls below the target range in the short-term, this can also lead to nausea, dizziness, sweating and—in the worst case—death of the diabetic. For this reason, it is imperative for a diabetic always to know his or her blood glucose level, and when appropriate to be able to instigate suitable measures independently in order to prevent the blood glucose value from exceeding or falling below the target range. For this purpose blood glucose meters have already been used for a long time, for example the ones which are known from DE 10 2004 057 503 A1 and are marketed by the Applicant under the registered trademark Accu-Chek®. In the ideal case, the diabetic takes care of measuring the blood glucose value and the measures which this entails under his or her own responsibility. The blood glucose level is subject to strong variations as a function of insulin intake (in general, insulins with different effects are used simultaneously), the amounts of sugar taken and other staple and luxury foods which physiologically affect the sugar metabolism. Physical movement, stress, disease and many other factors also affect the sugar metabolism. Since every body does not react in the same way to these physiological parameters, each diabetic must learn his or her own physiological reactions. For this purpose, it is important for the patient to use and work with his or her patient device regularly.

US 2003/0050537 A1 discloses a device for interactive rewarding, the device giving a reward when a medical test has been carried out by a patient or the patient has kept the results of his or her medical test at a desired level. The device consists, for example, of a blood glucose meter which can be connected to another independent device, which is in turn used to motivate or reward the patient. This other independent device is, in particular, a videogame console or a mobile telephone.

### SUMMARY

A medical patient device, for example a blood glucose meter, comprises a control unit having a microprocessor, a memory connected to the microprocessor, a medical module (measurement unit) for detecting and processing analysis-specific data with an interface for receiving and/or sending medically relevant data and a user interface, via which the results of a medical test can be output and a user can control and operate the medical patient device, for example in a manner which is known per se.

The medical patient device furthermore comprises a configuration module, which is connected to the microprocessor and by means of which the user interface can be operated by a user, and which is arranged so that a user can configure the blood glucose meter and, in particular, the user interface. This enables a user to adapt his or her medical patient device to his or her needs or preferences, and to individualize it. For this purpose, the configuration module accesses data loaded from external sources via an appropriately arranged interface of the patient device. The configuration options may comprise direct configuration settings, for example graphical configuration data such as for example photographs, icons, etc. and/or audio configuration files such as acoustic signals. Hence, the user can load the configuration data from an external source into the patient device via the configuration data interface.

This allows the user of a medical patient device, for example a blood glucose meter, to adapt the patient device to his or her needs and individualize it, which means that the user can identify better with his or her patient device. Patients, for example diabetics, are required to use a patient device regularly typically several times each day. The patient's future well-being depends on regular use of the patient device. However, it has been observed that a non-negligible number of patients find it difficult to accept or tolerate their patient device and, for example, develop aversions to preset alarm sounds, other acoustic signals or graphical representations on the display device of the user interface. Embodiments of the medical patient device provide each patient with the opportunity to adapt the technical parameters of his or her patient device to their personal needs. The associated individualization of the device can achieve a much greater level of identification by the patient with his or her patient device, which can in turn lead to more agreeable use of the device.

Embodiments of the medical patient device have a database containing configuration files, a connection between the medical patient device and the database being set up via the configuration data interface of the medical patient device, so that one or more configuration files can be loaded from the database into the medical patient device and stored there. The connection to the database may be established according to known methods, for example by means of cable, radio, Internet, infrared, Bluetooth, WLAN or the like. The database may be any type of external hard drive, for example in a server which is connected to via the Internet, an intranet, WLAN, etc., or for example in a portable device such as a digital recording device for still pictures, moving pictures and/or audio, for example in a portable computer, etc.

The present description also includes a computer program having program code, which leads to implementation of the invention when the computer program is run on a computer unit of a medical patient device. The computer program is claimed both as a computer program per se as and one which is stored on a computer-readable medium.

Further advantages and arrangements of the invention may be found in the description and the appended drawing.

It is to be understood that the features mentioned above and yet to be explained below may be used not only in the combination respectively indicated, but also in other combinations or separately, without departing from the scope of the present invention.

### BRIEF DESCRIPTION OF THE DRAWINGS

The invention is represented schematically with the aid of an exemplary embodiment in the drawing, and will be described in detail below with reference to the drawing.

FIG. 1 shows a block diagram of a medical patient device according to the invention.

### DETAILED DESCRIPTION

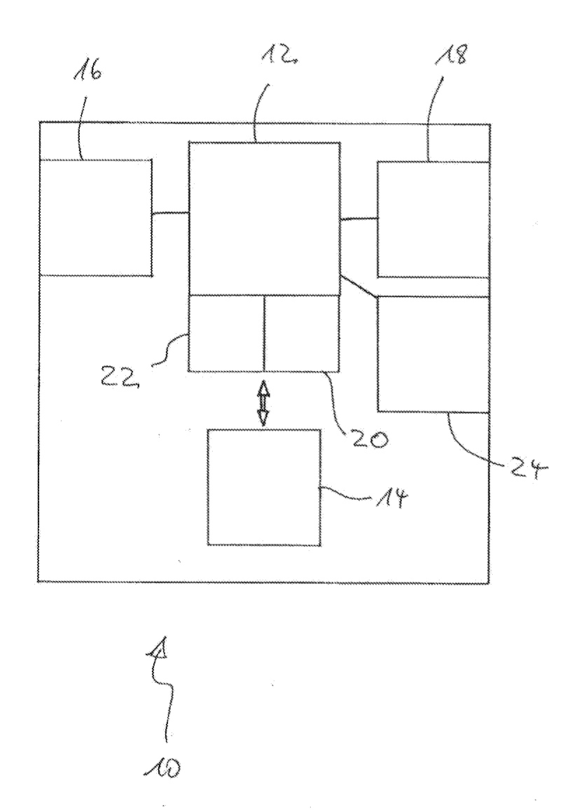

FIG. 1 shows a block diagram of a medical patient device 10 according to the invention. The medical patient device 10 comprises a computer unit 12, which may be a suitable microprocessor. The computer unit 12 is connected to a memory unit 14, which is used to store the data required for operation of the medical patient device 10. The medical patient device 10 furthermore comprises a measurement unit 18 for acquiring medical measurement data (for example blood glucose values) to be processed in the patient device. The measurement unit has an analytical test element, i.e. an interface designed for the acquisition of analysis-specific data. The data analysis is carried out in a manner known per se, for example by electrochemical or detection-photometric means.

These medical data records are processed by the computer unit 12 in a measurement data module 20 provided for this purpose, and they are suitably output optically/graphically and optionally acoustically to the user/patient via a user interface 16 provided for this purpose. For example, measurement data results and other relevant data calculated therefrom are presented to the user via a display unit (not shown) as numerical values and/or graphics. For visually impaired patients, the measurement values may also be output acoustically. Threshold value overshoots, times not complied with, etc. may furthermore be reported by signal sounds.

The data required for operation of the medical patient device 10 may be stored in various ways in the memory unit 14. On the one hand, data may already be stored in advance by the manufacturer. On the other hand, data may be input by a user via the user interface 16. Lastly, data may be input into the medical patient device 10 via other interfaces provided for this purpose. These interfaces are, for example, a medical data interface integrated into the measurement unit 18 and a configuration data interface 24.

The medical data interface is used, for example, to send values calculated by the measurement data module 20 to other connected or assigned devices. It is therefore a combined input/output interface, which may of course also be arranged as two interfaces.

The configuration data interface 24 is used to load configuration-relevant data records into the medical patient device 10 and store them there in the memory unit 14. These configuration-relevant data records (or configuration files for short) are data or data records or files, with the aid of which a user of the medical patient device 10 can configure the graphical user interface 16. For example, they are image data or image files which the user can select for display in the display unit (for example background images/photographs, or icons which can be used to call up particular routines of the computer unit and/or functions of the medical patient device). For this purpose, the patient device will have a suitable graphics processor (not shown). For example, they are also audio files which the user can select and which, having been assigned to particular events, are played back acoustically by the user interface, for example as an alarm signal when a medical threshold value is exceeded or fallen below. The audio files may be sounds, music recordings, tunes and/or spoken or sung text, for example announcements. For this purpose, the patient device will have a suitable sound processor (not shown) with an assigned loudspeaker.

Furthermore, moving pictures, for example films, screensavers, animations, etc. for optical and optionally also acoustic configuration of the user interface may also be loaded via the configuration data interface into the patient device, and stored in the memory unit, so that the patient can make configurations by using these files.

According to certain embodiments of the invention, the user-defined configuration may be set up in such a way that the activation (i.e. display and/or playback) of a file selected by the user is triggered by an associated event. The associated event may for example be a measurement value or a measurement interval, i.e. the associated file is activated when an acquired measurement value has a predetermined value or lies in a predetermined interval (this may involve intervals from a first measurement value to a second measurement value, or open intervals which cover all values above or below a particular measurement value, or specific measurement values; the measurement values or measurement value intervals may be selected from a list or specified individually).

This allows the user to assign a file with a content which he or she finds positive, for example a favorite tune, a fanfare, a favorite picture, a favorite clip, a favorite color, etc., to positive events i.e. measurement values which are beneficial for him or her, which represents a reward or motivation for a course of action which leads to a “good” measurement value. This is advantageous in particular for children or elderly people whose devices could be set accordingly by a doctor or a responsible person. This furthermore opens up the opportunity to arrange measurement value output entirely using images and/or sounds/tunes, which likewise makes it much easier for children and elderly people to use a patient device, or is the only thing which makes it possible, since it gives simplified comprehension of the measurement value indications (for example, a file with the color green may be assigned to good measurement value intervals, the color yellow/orange to less good but acceptable measurement value ranges, and the color red to critical measurement value ranges (traffic light principle)). Furthermore, conventional system settings, for example wake-up or alarm/reminder functions may correspondingly be arranged and configured on the part of the user.

The configuration data can, as described, be loaded via the configuration data interface 24 into the medical patient device 10. Further configuration options comprise setting the font style and font size, which is important for straightforward operation particularly in the case of blood glucose meters since many diabetics suffer visual impairments.

Further configuration options comprise noises and sounds of the patient device as well as luminous signals of the display unit. Vibration settings are also possible.

For the user to carry out the configuring, the computer unit 12 may comprise a configuration module 22. The configuration module 22 is programmed so that the user is shown the choice of configuration files available in the memory unit via a user interface. He or she can then make a selection and assign this selection to a particular event or a particular task or a particular display, etc. If he or she wishes to load new configuration files into the patient device, he or she may likewise do this with assistance from the configuration module. The configuration module therefore represents the operating program for managing and setting the configuration files.

The term medical patient device is not restricted to the blood glucose meter which has been described, but also extends to all devices which deal with medical procedures and are used or worked with by a patient himself or herself. These may in particular also be blood pressure monitors, pumps, control units, administering systems, lancing devices, etc. In the case of lancing devices, for example, one configuration option may consist in playing back an audio file selected by the patient at the same time as the prick, so that the patient is distracted from the prick and may possibly feel less pain. This can simplify use of the device for children and adolescents, who by now represent a large proportion of diabetics. The invention therefore allows personalization of a medical patient device, so that the patient can establish greater affinity with his or her device and integrate it better into his or her everyday life.

Thus, embodiments of the medical patient device are disclosed. One skilled in the art will appreciate that the teachings can be practiced with embodiments other than those disclosed. The disclosed embodiments are presented for purposes of illustration and not limitation, and the invention is only limited by the claims that follow.

What is claimed is:

1. A medical patient device, comprising:
a medical measurement unit for detecting and processing analysis-specific signals;
a computer unit;
a user interface; and,
a configuration data interface for receiving configuration files, the configuration data interface having a memory unit,
wherein the medical patient device is arranged and adapted so that by means of the user interface, a user can load configuration files into the patient device via the configuration data interface and store the configuration files in the memory unit, and can configure the user interface by accessing the downloaded configuration files stored in the memory unit.

2. The medical patient device as claimed in claim 1, wherein the configuration data interface is a wireless interface.

3. The medical patient device as claimed in claim 1, wherein configuring of the user interface comprises graphical/optical configuration of a display unit of the user interface.

4. The medical patient device as claimed in claim 1, wherein configuring of the user interface comprises acoustic configuration of a loudspeaker unit of the user interface.

5. The medical patient device as claimed in claim 1, wherein configuring is carried out by assigning a configuration file to a measurement value interval.

6. The medical patient device as claimed in claim 1, wherein configuring is carried out by means of files which contain moving pictures.

7. A patient system comprising a medical patient device as claimed claim 1, further comprising
a database containing configuration files, wherein a connection between the medical patient device and the database is set up via the configuration data interface of the medical patient device, such that one or more configuration files can be loaded from the database into the medical patient device and stored therein.

8. The patient system as claimed in claim 7, wherein the database is on a hard drive of a portable recording device.

9. The patient system as claimed in claim 7, wherein the database is on a stationary hard drive memory.

10. The patient system as claimed in claim 7, wherein the database can be connected to via a data network.

11. The patient system as claimed in claim 12, wherein the data network is a LAN, an intranet, or the Internet.

12. A computer program for controlling a medical patient device, wherein a computer program comprises program code which enables a user, by means of the user interface, to load configuration files into the patient device via the configuration data interface and store them in the memory unit, and to configure the user interface by accessing the downloaded configuration files stored in the memory unit, when the computer program is run on a computer unit of the medical patient device.

13. The computer program as claimed in claim 12, which is stored on a computer-readable medium.
